(19) United States
(12) Patent Application Publication
(10) Pub. No.: US 2025/0289374 A1
(43) Pub. Date: Sep. 18, 2025

(54) SWINGING TOOLBOX ASSEMBLY

(71) Applicant: Mustard Seed Concept & Design LLC, Brighton, CO (US)

(72) Inventors: John Kidd, Brighton, CO (US); David Livesay, Brighton, CO (US)

(73) Assignee: Mustard Seed Concept & Design LLC, Brighton, CO (US)

(21) Appl. No.: 19/077,908

(22) Filed: Mar. 12, 2025

Related U.S. Application Data
(60) Provisional application No. 63/564,167, filed on Mar. 12, 2024.

(51) Int. Cl. B60R 9/06

(52) U.S. Cl. CPC B60R 9/065

(57) ABSTRACT

Disclosed is a swinging toolbox assembly that has a swinging toolbox, a bearing assembly, and a frame. The swinging toolbox assembly is mounted on the rails of a vehicle and the swinging toolbox can swing from an unswung position that spans the width of the vehicle bed, to a swung position wherein the swinging toolbox rotates to the length of the bed of the vehicle. Attached to the frame that is mounted on rails of the vehicle bed are a front catch that mates with a front catch receiver on the swinging toolbox body, and a rear catch that mates with a rear catch receiver. The front catch coupled with the front catch receiver and the rear catch coupled with the rear catch receiver secure the swinging toolbox in the desired swung or unswung position.

### BACKGROUND

Toolboxes have been used to store various tools and equipment for various projects and can be very useful to have necessary tools and power equipment readily available in one box. Additionally, having a toolbox stored in a vehicle can be very convenient when tools and other equipment are needed at various locations, such as, but not limited to a job site.

### SUMMARY

An embodiment of the present invention may therefore comprise: a swinging toolbox assembly comprising: a frame configured to mount to a left rail, a right rail, and a bed width vertical face that extends between a driver side and a passenger side of a bed of a vehicle; the frame comprising: a left bracket configured to attach to the left rail of the vehicle; a right bracket configured to attach to the right rail of the vehicle; a crossmember configured to attach to the bed width vertical face of bed of the vehicle, and the left bracket being attached to a left side of the crossmember, and the right bracket being attached to a right side of the crossmember so that the crossmember is between the left bracket and the right bracket so that the left bracket and the right bracket are substantially parallel to each other and separated by a crossmember length; a bearing assembly configured to mount on top of the frame, and the bearing assembly comprising: a main body having a main body cylindrical space that goes through the main body, and the main body being configured to attach the frame; a ring bearing having an inner ring and an outer ring so that the inner ring is configured to rotate inside of the outer ring, and the outer ring being attached to the main body in the main body cylindrical space, and the inner ring having an inner ring gear with inner ring teeth; a drive motor attached to the main body inside of the main body cylindrical space, and the drive motor having a drive motor gear with drive motor gear teeth so that the drive motor gear teeth mate with the inner ring teeth of the inner ring gear of the inner ring of the ring bearing so that the drive motor is configured to rotate the inner ring of the ring bearing; a swinging toolbox mounted on the bearing assembly with the swinging toolbox having a swinging toolbox length that is longer than a swinging toolbox width, and the swinging toolbox is configured to rotate between an unswung and a swung position by the drive motor gear mating with the inner gear of the inner ring of the ring bearing so that the inner ring rotates the swinging toolbox; wherein when in the unswung position the swinging toolbox length spans between the driver side and the passenger side of the bed of the vehicle, and wherein when in the swung position the swinging toolbox length spans between a front of bed of the bed of the vehicle and a rear end of bed of the bed of the vehicle; a front catch mounted on the frame configured to secure the swinging toolbox by mating with a front catch receiver on the swinging toolbox so that when the front catch and the front catch receiver are mated with each other, the swinging toolbox is prevented from rotating in the bed of the vehicle; a rear catch mounted on the frame configured to secure the swinging toolbox by mating with a rear catch receiver on the swinging toolbox so that when the rear catch and the rear catch receiver are mated with each other, the swinging toolbox is prevented from rotating in the bed of the vehicle.

An embodiment of the present invention may therefore further comprise: a method of assembling a swinging toolbox assembly that is mounted a bed of a vehicle comprising: attaching a left bracket to a left side of a crossmember; attaching a right bracket to a right side of a right bracket so that the left bracket, the crossmember and the right bracket form a frame, and the right bracket and the left bracket are substantially parallel and separated between a length of the crossmember; attaching the frame to rails of a bed of a vehicle comprising: attaching a left shelf portion of the left bracket on a left rail of the vehicle so that the left bracket spans a left rail horizontal face of the vehicle, wherein the left rail horizontal face of the vehicle is a bed length that extends from a front of bed located adjacent to cabin of the vehicle to a rear end of the bed that is opposite the front of bed along the bed length; attaching a right shelf portion of the right bracket on a right rail of the vehicle so that the right bracket spans a right rail horizontal face of the vehicle, wherein the right rail horizontal face of the vehicle is the bed length that extends from the cabin of the vehicle to the rear end of the bed, and the cabin is located opposite the rear end and extends the bed length; attaching the crossmember to a bed width vertical face of the bed of the vehicle that extends a bed width of the bed of the vehicle wherein the bed width extends between a driver side of the vehicle and a passenger side of the vehicle; mounting a front catch to the to a right vertical portion of the right bracket of the frame, wherein the right vertical portion is substantially perpendicular to the right shelf portion of the right bracket; mounting a rear catch to the to a left vertical portion of the left bracket of the frame, wherein the left vertical portion is substantially perpendicular to the left shelf portion of the left bracket; attaching a bearing assembly to the left bracket and the crossmember of the frame so that a left horizontal portion of a main body of the bearing assembly is attached to the left shelf portion of the left bracket and a right horizontal portion of the main body of the bearing assembly is attached to the crossmember; attaching a ring bearing to a horizontal upper portion of the main body of the bearing assembly so that an outer ring of the ring bearing is surrounds a main body cylindrical through hole of the main body of the bearing assembly; mating drive motor gear teeth of a drive motor gear with inner ring teeth of an inner ring gear located inside of an inner ring of the ring bearing so that the mating of drive motor gear teeth and the inner ring teeth causes the inner ring to rotate inside of the outer ring when the drive motor gear rotate; mounting a swinging toolbox to the bearing assembly by attaching an upper shelf of a swinging toolbox body to the inner ring of the ring bearing so that a cylindrical through hole located on the upper shelf aligns with the main body cylindrical through hole of the bearing assembly so that the swinging toolbox rotates between an unswung position and a swung position inside of the bed of the vehicle when the inner ring gear rotates with the drive motor gear, wherein a swinging toolbox length of the swinging toolbox spans the bed width in the unswung position, and the swinging toolbox length spans the bed length in the swung position; mounting a front catch receiver in a front hole of the swinging toolbox body so that the front catch receiver mates with the front catch when the swinging toolbox is in the unswung position and the swinging toolbox is prevented from rotating when the front catch and the front catch receiver are mated together; mounting a rear catch receiver in a rear hole of the swinging toolbox body so that the rear catch receiver mates with the rear catch when the swinging toolbox is in the swung position and the swinging toolbox is prevented from rotating when the rear catch and the rear catch receiver are mated together; attaching a right lid to a right lid catch on the swinging toolbox body; attaching a left lid to a left lid catch on the swinging toolbox body; mounting a controller inside of a controller through hole on the left lid so that the controller can be used and accessed on top of the left lid when the left lid is closed so that the controller controls the left lid, the right lid, the front catch receiver, and the rear catch receiver.

An embodiment of the present invention may therefore further comprise: a method of using a swinging toolbox of a swinging toolbox assembly mounted on a bed of a vehicle comprising: positioning the swinging toolbox in an unswung position so that a swinging toolbox length of the swinging toolbox extends along a bed width between a driver side and a passenger side of the vehicle, and wherein the swinging toolbox has a bearing assembly side attached to a bearing assembly having a ring bearing that allows rotation of the swinging toolbox, and a catch side that secures the swinging toolbox to a frame mounted on a rail of the vehicle and the bearing side is opposite the catch side along the swinging toolbox length; securing the swinging toolbox in an unswung position by mating a front catch receiver located on the catch side of the swinging toolbox with a front catch located on the frame of the swinging toolbox assembly and wherein the frame is mounted on the rail of the vehicle so that the front catch receiver mated with the front catch maintains the swinging toolbox in the unswung position; rotating the swinging toolbox secured to the front catch from a the unswung position to a swung position so that the catch side rotates about the bearing assembly side inside of the bed of the vehicle comprising: disconnecting the front catch receiver from the front catch; rotating the catch side of the swinging toolbox away from a front of bed that is adjacent to a cabin side of the bed and towards a rear of bed located opposite from the front of bed along a bed length of the bed of the vehicle; positioning the swinging toolbox in an unswung position so that the swinging toolbox length of the swinging toolbox extends along the bed length of the bed of the vehicle; securing the swinging toolbox in a swung position by mating a rear catch receiver located on the catch side of the swinging toolbox with a rear catch located on the frame of the swinging toolbox assembly so that the rear catch receiver mated with the rear catch maintains the swinging toolbox in the swung position; rotating the swinging toolbox in an unswung position to a swung position by disconnecting the rear catch receiver from the rear catch and rotating the catch side about the bearing side so that the catch side is rotated away from the rear of bed and towards the front of bed until the swinging toolbox length of the swinging toolbox extends along the bed width of the bed of the vehicle.

### BRIEF DESCRIPTION OF THE DRAWINGS

FIG. 1 is a schematic illustration of swinging toolbox assembly in the unswung position in the bed of a vehicle.

FIG. 2 is a schematic illustration of the swinging toolbox assembly of FIG. 1 in the swung position in the bed of the vehicle of FIG. 1.

FIG. 3 is a schematic illustration of the frame and bearing assembly attached to the rails of the bed of the vehicle of FIG. 2.

FIG. 4 is an exploded view of the swinging toolbox assembly 100 of FIGS. 1 and 2.

FIG. 5 is an exploded assembly view of the frame of FIG. 4.

FIG. 6 is a schematic illustration of the swinging toolbox assembly of FIGS. 1-4.

FIG. 7 is a schematic illustration of the frame of FIG. 5.

FIG. 8 is an exploded assembly view of the bearing assembly of FIGS. 3 and 4.

FIG. 9 is a schematic illustration of the bearing assembly 3, 4, and 8.

FIG. 10 is an exploded assembly view of the swinging toolbox of FIGS. 1-2, 4, and 6.

FIG. 11 is a schematic illustration of the swinging toolbox of FIGS. 1-2, 4, 6, and 10.

### DETAILED DESCRIPTION OF THE EMBODIMENTS

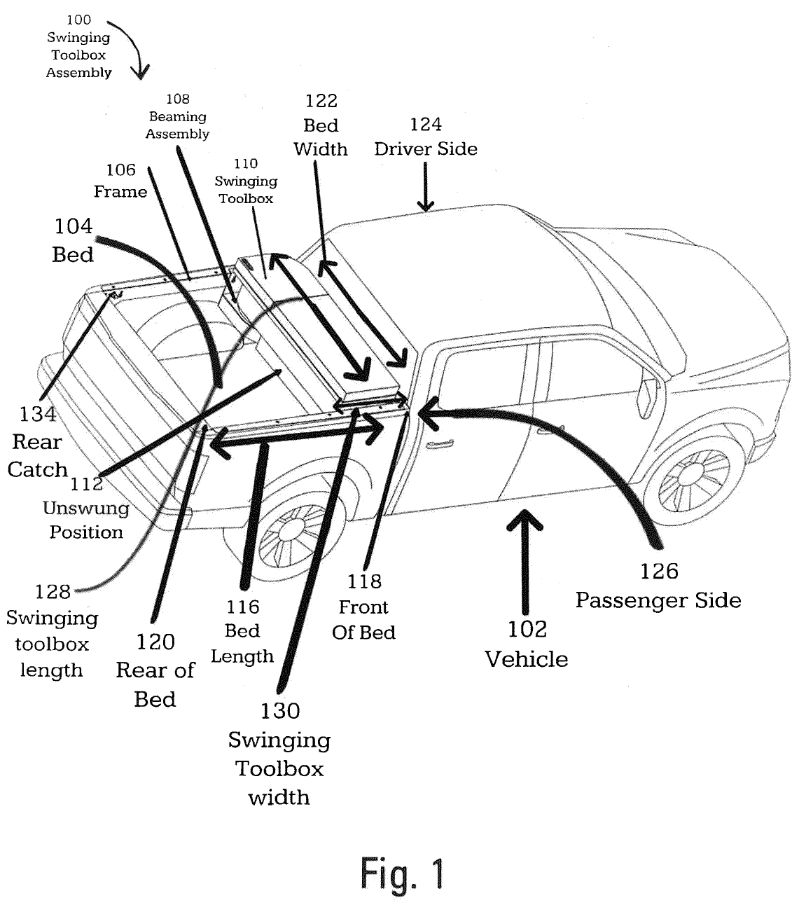

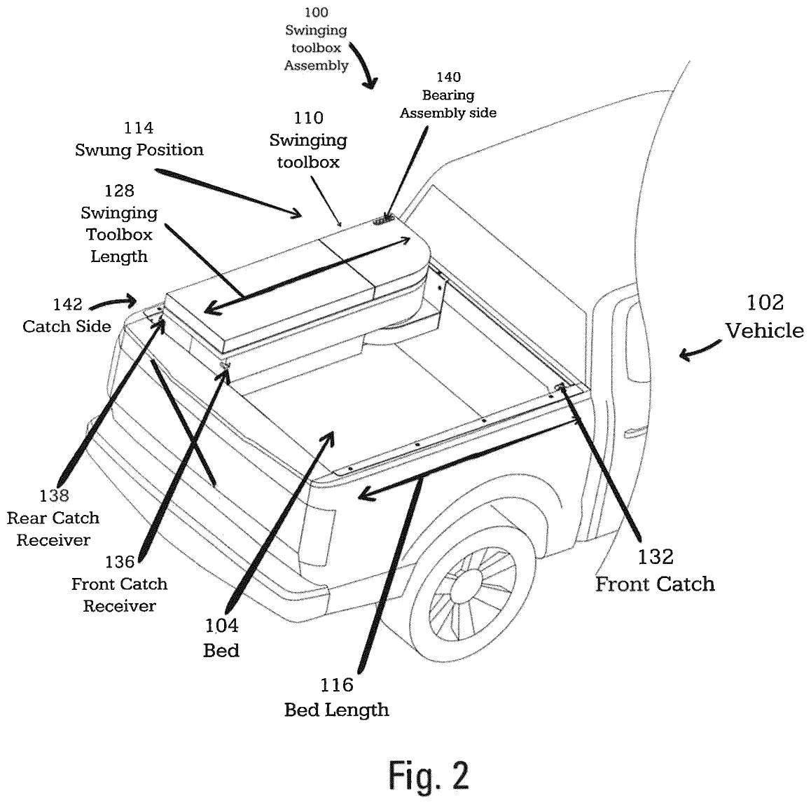

FIG. 1 is a schematic illustration of an embodiment of a swinging toolbox assembly 100 installed in a bed 104 of a vehicle 102. Swinging toolbox assembly 100 comprises a frame 106, a bearing assembly 108 and a swinging toolbox 110. Swinging toolbox 110 shown in FIG. 1 in an unswung position 112, as opposed to a swung position 114 later shown and described in FIG. 2.

As shown in FIG. 1, the bed 104 of the vehicle 102 has a bed length 116 spanning between front of bed 118 and rear of bed 120. Additionally, bed 104 has a bed width 122 that spans between a driver side 124 and a passenger side 126, with bed length 116 being substantially perpendicular to bed width 122. Additionally, swinging toolbox 110 has a swinging toolbox length 128, and a swinging toolbox width 130, with the swinging toolbox length 128 being longer than the swinging toolbox width 130, and the swinging toolbox length 128 being substantially perpendicular to the swinging toolbox width 130 (as illustrated in FIG. 1). When the swinging toolbox 110 is in an unswung position (as illustrated in FIG. 1), the swinging toolbox length 128 spans along the bed width 122 between driver side 124 and passenger side 126. Additionally, FIG. 1 shows rear catch 134 attached to frame 106 which is further discussed in FIG. 2 below.

Similarly to FIG. 1, FIG. 2 is a schematic illustration of the swinging toolbox assembly 100 installed in the bed 104 of vehicle 102. In contrast to FIG. 1 that illustrates swinging toolbox 110 in the unswung position 112, FIG. 2 illustrates swinging toolbox 110 in the swung position 114. In other words, swinging toolbox 110 was rotated from the unswung position 112 in FIG. 1, and repositioned so that the swinging toolbox length 128 spans along bed length 116.

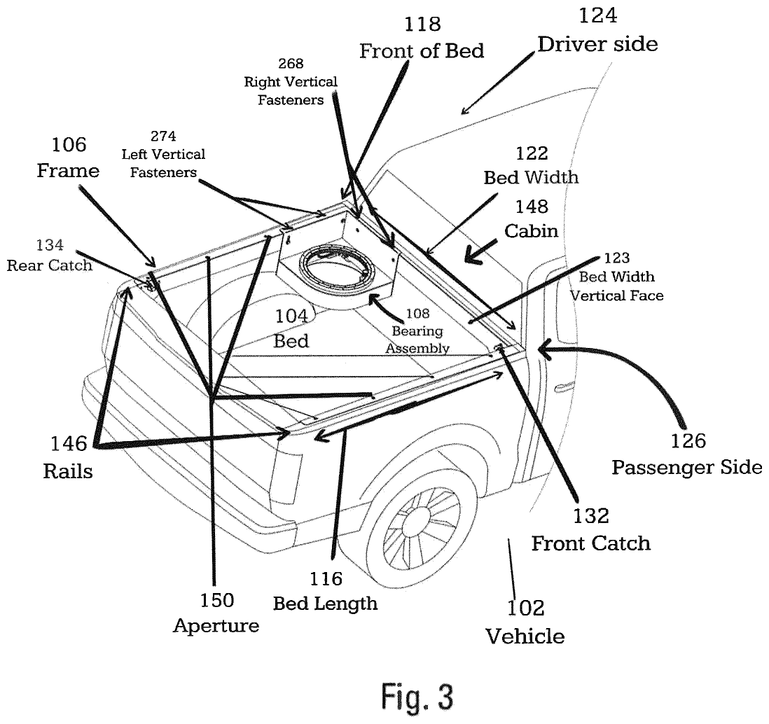

Also shown in FIG. 2, swinging toolbox 110 has a bearing assembly side 140, and a catch side 142 which are located opposite each other along the length of the swinging toolbox 110. The bearing assembly side 140 is where the center of rotation occurs and enables the swinging toolbox 100 to rotate. The catch side is the side that secures the swinging toolbox 110 to the frame 106 when rotation of the swinging toolbox 110 is not desired. More specifically, front catch receiver 128 on swinging toolbox 110 mates with front catch 132 on frame 106 to secure swinging toolbox 110 in the unswung position (FIG. 1). Similarly, rear catch receiver 130 mates with rear catch 134 (see FIGS. 1 and 3) to secure swinging toolbox 110 in the swung position, as depicted in FIG. 2. In other words, when swinging toolbox 110 is desired to be in either the unswung or swung position, catch receivers (136, 138) on swinging toolbox 110 mate with either catch (132,134) on frame 106 so that the catch side 142 of the swinging toolbox 110 is prevented from rotating. The catch side 142 of the swinging toolbox 110 being secured prevented from rotating is important and desired in various circumstances such as while traveling and while removing heavy equipment from swinging toolbox 110, as non-limiting examples. It should be noted that front catch 132 and front catch receiver 136, as well as rear catch 138 and rear catch receiver 138 can be any latch and/or locking mechanism that secures the swinging toolbox 110 in the desired position and prevents rotation. Non-limiting examples of latch and/or locking mechanisms that can be used are: bear claw, bar and lever, magnetic, rubber draw latches, spring latches, slam latches, or other latching systems known in the art.

There are many advantages of the swinging toolbox 110 being able to easily rotate between the unswung 112 and swung positions 114. Because the swinging toolbox 110 is able to rotate between unswung 112 and swung 114 positions, a user can simply swing the swinging toolbox 110 in the position desired, while also having the swinging toolbox 110 secured in each position (112,114). In contrast, a user would typically have to remove a heavy toolbox from the bed, or re-arrange the toolbox manually in another position in bed 104, which such rearrangement likely not providing a toolbox to remain in position.

Additionally, there are advantages for each position. For example, the swung position 114 allows users of the swinging toolbox 110 to easily access tools and other components stored in the swinging toolbox 110 without having to climb onto bed 104 or walk to the other side of the vehicle 102 to access tools a user may not be able to reach. Instead, components within the swinging toolbox 110 can be accessed from the side of vehicle 102. Additionally, while in the swung position, the entire bed length 116 can be utilized since the swinging toolbox 110 has been positioned out of the way; i.e. as opposed to the swinging toolbox width 130 taking up bed length 116 space while in the unswung position 112. This can be very useful for transporting things such as, but not limited to long furniture and mattresses, as a non-limiting example of the entire bed length 116 being utilized. In a similar manner, a user can easily rotate the swinging toolbox 110 to the unswung position 112 so the entire bed width 122 can be utilized. The swinging toolbox assembly 102 can be easily rotated between unswung 112 and swung 114 positions as needed, without having to lift or move a heavy toolbox.

FIG. 3 is a schematic diagram of a bearing assembly 144 installed onto frame 106. The bearing assembly 144 allows the swinging toolbox 110 to rotate back and forth from the unswung 112 and swung position 114 (illustrated in FIGS. 1-2). As shown in FIG. 3, frame 106 is attached to the rails 146 of the bed 104 of vehicle 102 and spans along bed length 116 on driver side 124, across bed width 122, and along bed length 116 on passenger side 126. In other words, frame 106 is attached to the already existing rails 146 of the bed 104 of vehicle 102 and extends along the bed length 116 of each side (driver side 12 and passenger side 124), and along the bed width 122 that is located adjacent to a cabin 148 of vehicle 102. As shown in FIG. 3, frame 106 has frame apertures 150 that can align with already existing apertures (not shown) that run along the rails 146 of many vehicle 102 models. Frame 106 can be attached to rails 146 by various means, such as fasteners going through apertures 150 of frame 106 and through already existing apertures (not shown) that run along the rails 146. Non-limiting examples of fasteners include, but are not limited to: pegs, bolts, posts, or by other fasteners known in the art. Additionally, other methods can be used to mount frame 106 to rails 146 of vehicle 102 such as adhesives or magnets, as non-limiting examples, as well as other securing means known in the art. Additionally, bearing assembly 144 can be attached to frame 106 by bolts, posts, adhesives, or any other securing means known in the art. Additionally, FIG. 3 shows bed width vertical face 123 that is part of bed 104 of vehicle 102 and spans along bed width 122 on the vertical face inside of bed 104 along the front of bed 118. Right vertical fasteners 268 and left vertical fasteners 274 are used to secure bearing assembly 108 to frame 106.

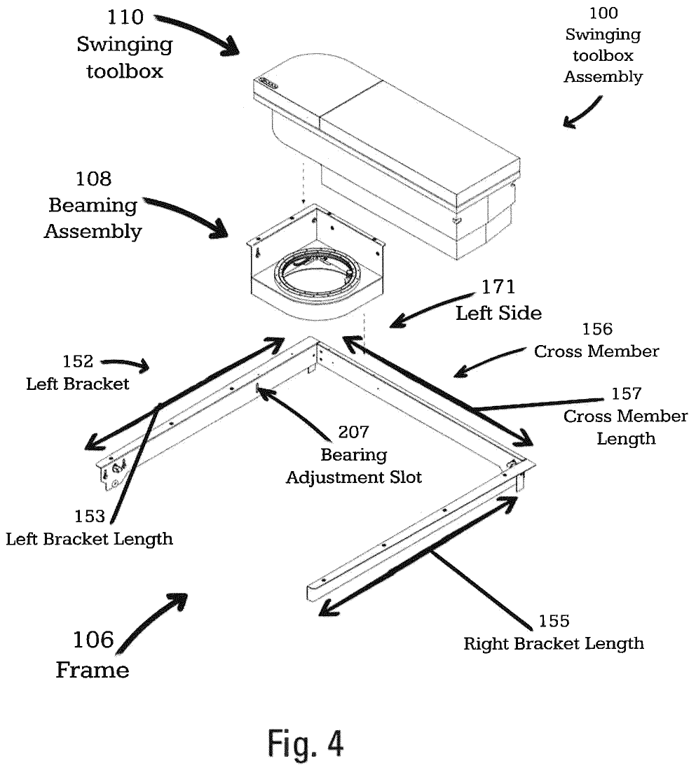

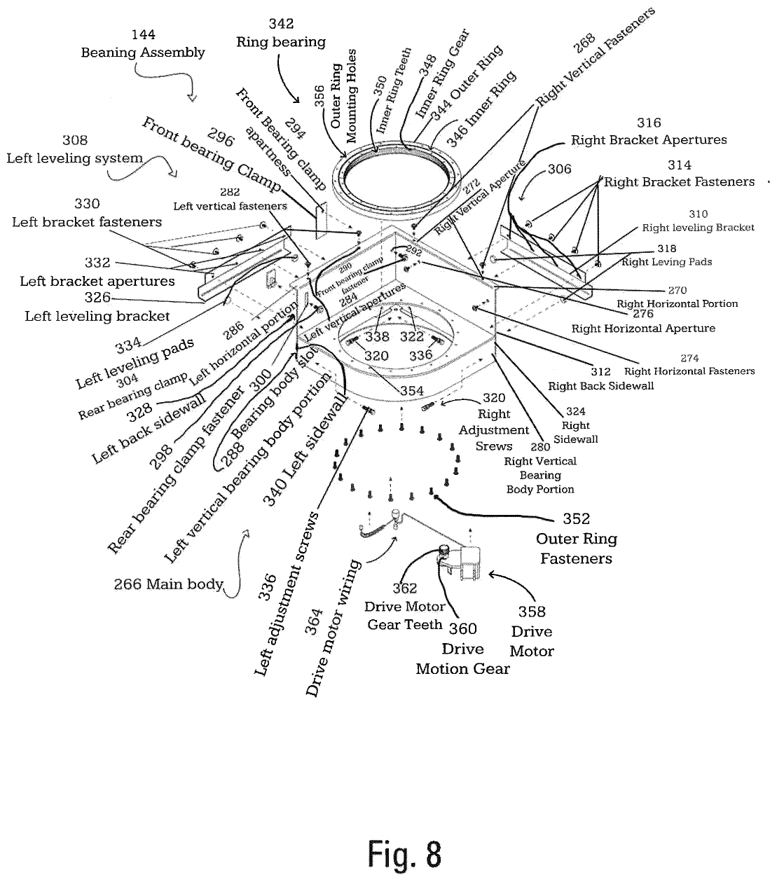

FIG. 4 is an exploded view of the swinging toolbox assembly 100 which comprises frame 106, bearing assembly 108 and swinging toolbox 110. Frame 106 has a left bracket 152 having a left bracket length 153, a right bracket 154 having a right bracket length 155, and a crossmember 156 having a crossmember length 157. Additionally, crossmember 156 has a left side 171 where left bracket 152 attaches to the left side 171 of crossmember 156, and right side 173 where right bracket 154 attaches to the right side 173 of crossmember 156. As illustrated in FIG. 4, left side 171 and right side 173 of crossmember 156 are located on opposite ends of crossmember 156 and separated by crossmember length 157. To assemble the swinging toolbox assembly 100 to vehicle 102, frame 106 is mounted on rails 146 (FIGS. 1-3) of the bed 104 of vehicle 102 (FIGS. 1-3), bearing assembly 108 is mounted to frame 106 and swinging toolbox 110 is mounted on bearing assembly 108. FIG. 4 also shows a bearing adjustment slot 207 located on frame 106 that is later discussed in FIG. 8.

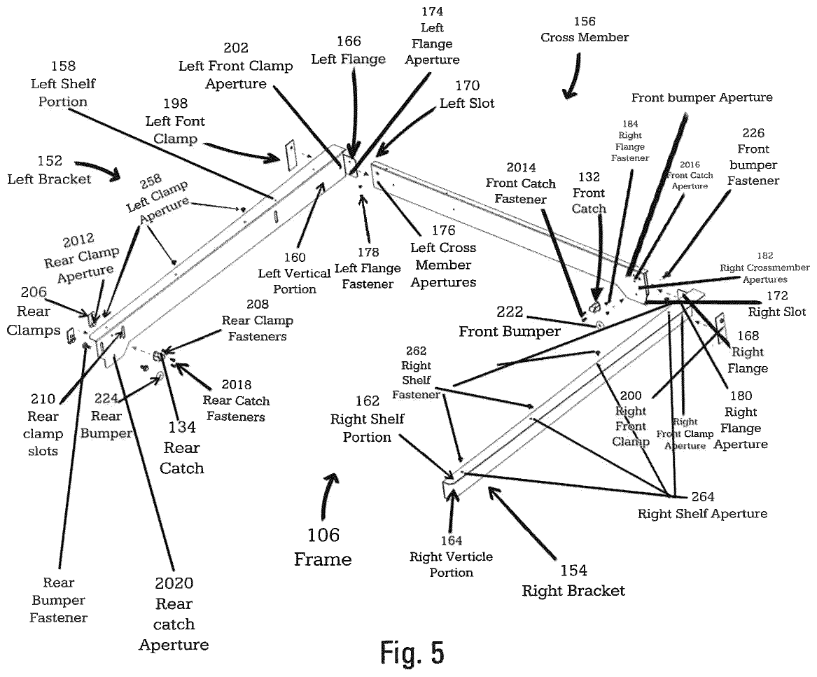

FIG. 5 is an exploded assembly view of frame 106 and further illustrates the assembly of front catch 132 and rear catch 134 to frame 106. As shown in FIG. 5, left bracket 152 and right bracket 154 are substantially parallel to each other and separated by the length 157 of crossmember 156, so that crossmember 156 is substantially perpendicular to both the left and right brackets (152, 154 respectively). Left bracket 152 has left shelf portion 158 and a left vertical portion 160. Left shelf portion 158 protrudes from left vertical portion 160 in an axial direction away from bed 104. Left vertical portion 160 protrudes in a downward vertical direction away from the left shelf portion 158 so that the left shelf portion 158 and the left vertical portion 160 are substantially orthogonal to each other. Similarly, right bracket 154 has a right shelf portion 162 and a right vertical portion 164 with the right shelf portion 162 protruding in an axial direction away from bed 104, and the right vertical portion 164 protruding in a downward vertical direction away from the right shelf portion 162 so that the right shelf portion 162 and the right vertical portion 164 are substantially orthogonal to each other. Left bracket 152 has a left flange 166 that protrudes laterally from the left vertical portion 160 towards crossmember 156 and the left flange 166 is substantially orthogonal to both the left shelf portion 158 and the left vertical portion 160. In other words, both the left shelf portion 158 and the right shelf portion 162 span bed length 116 (FIGS. 1-3) and protrude in an axial direction away from bed 104 so that each of the left shelf portion 158 and the right shelf portion 162 can be mounted on top of one of the respective rails 146 of vehicle 102, as illustrated in FIGS. 1-3. Additionally, both the left vertical portion 160 and the right vertical portion 164 span the bed length 116 for each respective side of bed 104 of vehicle 102, as shown in FIGS. 1-3, and protrude away from each respective left shelf portion 158 and right shelf portion 162 in a downward vertical direction towards the inside of bed 104 (FIGS. 1-3). Similar to left bracket 152, right bracket 154 has a right flange 168 that protrudes from the right vertical portion 164 in a lateral direction towards crossmember 156.

FIG. 5 further illustrates the assembly of frame 106. Frame 106 is assembled by inserting left flange 166 into a left slot 170 of crossmember 156 and inserting right flange 168 into a right slot 172 of crossmember 156. Left flange apertures 174 on left flange 166 align with left crossmember apertures 176 on crossmember 156. Left flange fasteners 178 are inserted into and through left flange apertures 174 and left crossmember apertures 176, thereby securing left bracket 152 with crossmember 156. Similarly, right flange apertures 180 on right flange 168 align with right crossmember apertures 182 on crossmember 156. Right flange fasteners 184 are inserted into and through right flange apertures 180 and right crossmember apertures 182, thereby securing right bracket 154 with crossmember 156. Non-limiting examples of left and right flange fasteners (178, 184) are screws, nails, nuts and bolts, anchors, rivets, or any other type of fastener known in the art. Additionally, it should be noted that left and right flanges (166, 168) can be secured inside of left and right slots (170, 172) of crossmember 156 in various ways known in the art, such as using an adhesive or welding, as non-limiting examples. In other words, left and right flange fasteners (178, 184), left and right flange apertures (174, 180) and left and right crossmember apertures (176, 182) could be eliminated by using other securing methods such as adhesives or welding as non-limiting examples of securing left and right flanges (166, 168) inside of left and right slots (170, 172) of crossmember 156. However, securing methods such as adhesives or welding can also be used in addition to using left and right flange fasteners (178, 184), left and right flange apertures (174, 180) and left and right crossmember apertures (176, 182), as previously discussed.

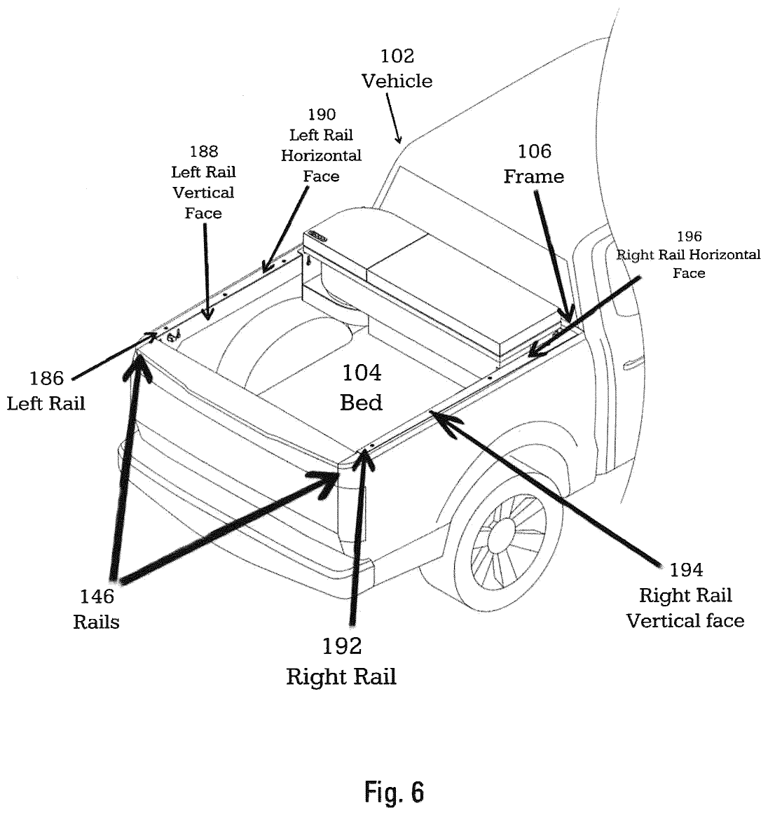

FIG. 6 is a schematic illustration of the swinging toolbox assembly 100 installed in the bed 104 of vehicle 102 and further illustrates rails 146 of vehicle 102. As previously discussed in FIG. 3, rails 146 of bed 104 are part of vehicle 102 and are located underneath frame 106. As shown in FIG. 6, left rail 186 has a left rail vertical face 188 that spans the vertical inside face of bed length 116 (FIG. 3) inside of bed 104, and a left rail horizontal face 190 that spans horizontally along the bed length 116 (FIG. 3). Left rail vertical face 188 spans in a vertical plane that is substantially perpendicular to the horizontal plane of rail horizontal face 190. As previously noted, rails 146 are part of vehicle 102 and are located underneath frame 106 which is shown already installed on rails 146 of vehicle 102.

Referring to FIG. 5, left front clamp 198 and right front clamp 200 assist in securing the left and right vertical portions (160, 164) of the left and right brackets (152, 154) to left and right rails (see FIG. 6; 186, 192) respectively. More specifically, the left front clamp 198 is mounted between the left rail vertical face 188 of bed 104 (shown in FIG. 6) and the left vertical portion 160 of left bracket 152. To mount the left front clamp 198 between the left bracket 152 and the left rail vertical face 188 of vehicle 102 (FIG. 6), a fastener (not shown) goes through a left front clamp aperture 202 located on the left vertical portion 160 of left bracket 152 and into the left rail vertical face 188 (FIG. 6) of the left rail 186 so that the left vertical portion 160 of left bracket 152 is secured in place to left rail 186 (FIG. 6). Similarly, the right front clamp 200 is mounted between the right rail vertical face 194 of bed 104 (shown in FIG. 6) and the right vertical portion 164 of right bracket 154. To mount the right front clamp 200 between the right bracket 154 and the right rail vertical face 194 of vehicle 102, a fastener (not shown) goes through a right front clamp aperture 204 located on right vertical portion 164 of right bracket 154 and into the right rail vertical face 194 (FIG. 6) of right rail 192 so that the right vertical portion 164 of right bracket 154 is secured in place to the right rail 192 (FIG. 6).

FIG. 5 also shows rear clamps 206 that assist in mounting the left vertical portion 160 of left bracket 152 to the left vertical face 188 of vehicle 102 (FIG. 6). Similar to the left front clamp 198 earlier discussed, rear clamps 206 are mounted between the left bracket 152 and the left rail vertical face 188 of vehicle 102 (FIG. 6). Rear clamp fasteners 208 are inserted into rear clamp slots 210, through rear clamp apertures 2012, and into the left rail vertical face 188 (FIG. 6) of left rail 186 (FIG. 6) so that the left vertical portion 160 of left bracket 152 is secured to the left rail vertical face 188 (FIG. 6) of left rail 186 (FIG. 6). Rear clamp slots 210 span in a vertical direction to allow for any vertical adjustments that may be desired.

As earlier discussed in FIGS. 1-4, front catch 132 and rear catch 134 are attached to frame 106. As shown in FIG. 5, front catch 132 is secured to crossmember 156 by inserting front catch fasteners 214 through apertures (not shown) in the front catch 132, and into front catch apertures 216 located on crossmember 156. Similarly, rear catch 134 is secured to the left vertical portion 160 of left bracket 152 by inserting rear catch fasteners 218 through apertures (not shown) in the rear catch 134, and into rear catch apertures 220 located on the left vertical portion 160 of left bracket 152. As shown in FIG. 5, front bumper 222 and rear bumper 224 are located on the vertical portions of the crossmember 156 and the left bracket 152. Front bumper 222 and rear bumper 224 are made of an elastic shock absorbing material that provides elasticity when the swinging toolbox 110 (FIGS. 1-2) is swung and latched. Front bumper 222 is attached to crossmember 156 by inserting front bumper fastener 226 through front bumper aperture 228 located on crossmember 156, and into front bumper 222. Front bumper 222 protects the outer surface of crossmember 156 and the outer surface of the swinging toolbox 110 (FIGS. 1-2) by providing an elastic shock absorbing material between the crossmember 156 surface and the swinging toolbox 110 (FIGS. 1-2). Similarly, rear bumper 224 is attached to the left vertical portion 160 of left bracket 152 by inserting rear bumper fastener 230 through rear bumper aperture 232 and into rear bumper 224. Rear bumper provides an elastic material between the swinging toolbox 110 (FIGS. 1-2) and the left vertical portion 160 of left bracket 152 to protect the outer surfaces of the swinging toolbox 110 (FIGS. 1-2) and the left vertical portion 160 of left bracket 152. Non-limiting examples of elastic materials used for front and rear bumpers (222, 224) include: rubber, elastin, polymers, neoprene, silicone, and other materials known in the art that provide shock absorption. Additionally, other methods can be used to mount front and rear bumpers (222, 224) to frame 106. Other mounting methods include, but are not limited to using adhesives, magnets, hook and loop, as well as other securing methods known in the art.

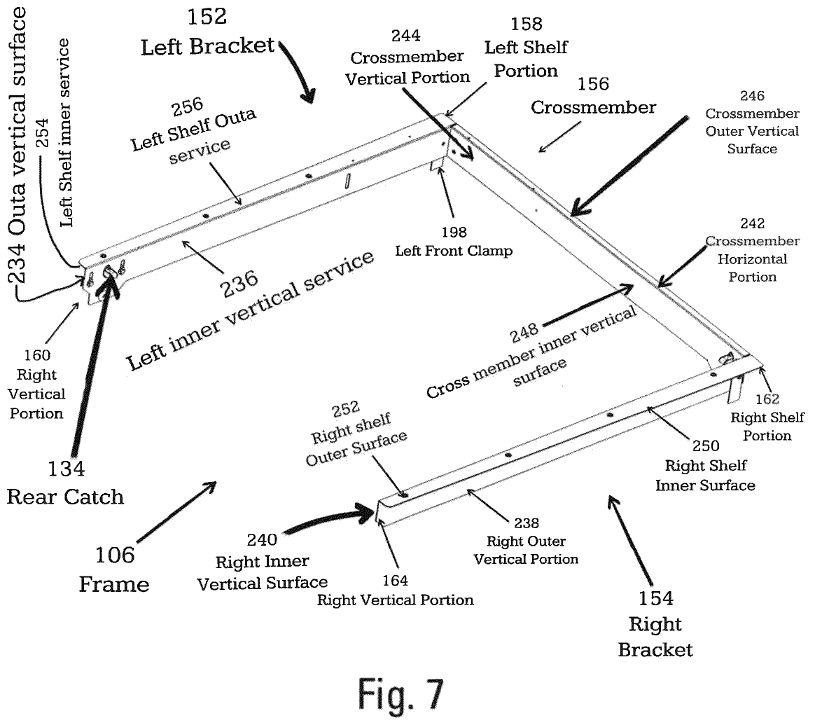

FIG. 7 is a schematic illustration of frame 106 fully assembled. As shown in FIG. 7, left vertical portion 160 of left bracket 152 has a left outer vertical surface 234 that faces the left rail vertical face 188 (FIG. 6), and a left inner vertical surface 236 that faces the inside of bed 104 (FIG. 6). Similarly, right vertical portion 164 of right bracket 154 has a right outer vertical surface 238 that faces the right rail vertical face 194 (FIG. 6), and a right inner vertical surface 240 that faces the inside of bed 104 (FIG. 6). Additionally, crossmember 156 has a crossmember horizontal portion 242 and a crossmember vertical portion 244. Crossmember vertical portion 244 spans along bed width 122 (FIG. 3) and in a downward vertical direction towards bed 104. Crossmember vertical portion 244 has a crossmember outer vertical surface 246 that faces the bed width vertical face 123 of bed 104 of vehicle 102 (shown and described in FIG. 3), and a crossmember inner vertical surface 248 that faces the inside of bed 104 (FIG. 3). FIG. 7 also further illustrates left front clamp 198 attached to the left outer vertical surface 234 of frame 106, and right front clamp 200 attached to the right outer vertical surface 238 of frame 106. FIG. 7 also shows right shelf portion 162 of right bracket 154 having a right shelf inner surface 250 that faces down towards the right rail horizontal face 196 (FIG. 6) and a right shelf outer surface 252 that faces an upward direction away from bed 104. Similarly, left shelf portion 158 of left bracket 152 has a left shelf inner surface 254 that faces down towards the left rail horizontal face 190 (FIG. 6), and a left shelf outer surface 256 that faces an upward direction away from bed 104.

Referring to FIG. 5, frame 106 is attached to rails 146 (FIG. 6) by inserting left shelf fasteners 258 through left shelf apertures 260 located on the left shelf portion 158 of left bracket 152 and into the left rail 186, and inserting right shelf fasteners 262 through right shelf apertures 264 located on the right shelf portion 162 and into right rail 192. Non-limiting examples of fasteners include, but are not limited to: pegs, bolts, posts, or by other fasteners known in the art. Additionally, other methods can be used to mount frame 106 to rails 146 of vehicle 102 such as adhesives or magnets, as non-limiting examples, as well as other securing means known in the art.

FIG. 7 is an exploded assembly view of bearing assembly 144 that was previously discussed in FIGS. 1, 3, and 4. The bearing assembly 144 has a main body 266 that is attached to frame 106 (see FIGS. 3-4). The bearing assembly 144 is the primary means for supporting the weight of the swinging toolbox 110 (FIG. 1), as well as providing the means for the swinging toolbox 110 (FIG. 1) to rotate to and from the unswung position 112 (FIG. 1) and the swung position 114 (FIG. 2). The bearing assembly 144 is attached to frame 106 (FIGS. 3-4) by inserting right vertical fasteners 268 through right vertical apertures 272 of right horizontal portion 270 and into the crossmember horizontal portion 242 (FIG. 7) of frame 106 (FIG. 7), as illustrated in FIG. 3. To attach the right vertical bearing body portion 280 of main body 266 to frame 106 (FIG. 3), right horizontal fasteners 274 are inserted through right horizontal apertures 276 and into the crossmember vertical portion 244 (FIG. 7) of frame 106, as illustrated in FIG. 3. Similarly, left vertical fasteners 282 are inserted through left vertical apertures 284 located on left horizontal portion 286 of main body 266, and into the left shelf portion 158 of frame 106 (FIGS. 5 and 7), as illustrated in FIG. 3. To attach the left vertical bearing body portion 288 of main body 266 to frame 106 (FIG. 3), front bearing clamp fastener 290 is inserted through aperture 292 on the left vertical bearing body portion 288 and inserted through front bearing clamp aperture 294 on front bearing clamp 296 and into the left vertical portion 160 of frame 106 (FIG. 7), as illustrated in FIG. 3. Additionally, rear bearing clamp fastener 298 is inserted through a bearing body slot 300 located on left vertical bearing body portion 288 and through rear bearing clamp aperture 302 on rear bearing clamp 304 and into the left vertical portion 160 of frame 106 (FIG. 7), as illustrated in FIG. 3. The bearing body slot 300 allows space to make any desired vertical adjustments of the position of main body 266 attached to frame 106 (FIG. 3).

Bearing assembly 144 has a right leveling system 306 and a left leveling system 308 that assists in adjusting the main body 266 for desired horizontal adjustments. Right leveling system 306 has a right leveling bracket 310 that attaches to a right back sidewall 312 by inserting right bracket fasteners 314 through right bracket apertures 316 and into the right back sidewall 312 of main body 266 so that the right leveling system 306 is secured to the bottom portion of the right back sidewall 312. Right leveling pads 318 are disposed between the right leveling bracket 310 and the right back sidewall 312 of main body 266. Right adjustment screws 320 are inserted in right adjustment apertures 322 through right sidewall 324. Right adjustment screws 320 are adjusted against the right leveling pads 318 so that horizontal adjustments can be made for the position of the main body 266 mounted on frame 106 (FIG. 3). Similarly, left leveling system 308 has a left leveling bracket 326 that attaches to a left back sidewall 328 by inserting left bracket fasteners 330 through left bracket apertures 332 and into the left back sidewall 328 of main body 266 so that the left leveling system 308 is secured to the bottom portion of the left back sidewall 328. Left leveling pads 334 are disposed between the left leveling bracket 326 and the left back sidewall 328 of main body 266. Left adjustment screws 336 are inserted in left adjustment apertures 338 and through left sidewall 340. Left adjustment screws 336 are adjusted against the left leveling pads 334 so that horizontal adjustments can be made for positioning the main body 266 mounted on frame 106 (FIG. 3).

Still referring to FIG. 8, bearing assembly has a ring bearing 342 that comprises an outer ring 344 and an inner ring 346. The ring bearing 342 shown in FIG. 8 is a slew ring style bearing where inner ring 346 rotates inside of and in relation to outer ring 344. The inner ring 346 has an inner ring gear 348 with inner ring teeth 350. Ring bearing 342 is mounted to the main body 266 by inserting outer ring fasteners 352 through main body apertures 354 and into outer ring mounting holes 356 so that the ring bearing is secured to main body 266. FIG. 8 also shows a drive motor 358 with a drive motor gear 360, drive motor gear teeth 362, and drive motor wiring 362 that is disposed in main body 266. It should be noted that outer ring fasteners 352 can be any fastener that securely attaches outer ring 344 to main body 266. Non-limiting examples of fasteners include, but are not limited to: pegs, bolts, posts, or by other fasteners and fastening methods known in the art. Additionally, it should be noted that the bearing assembly 144 is the primary means of supporting the swinging toolbox 110, as indicated in FIGS. 1 and 2; i.e. FIGS. 1 and 2 make apparent that the swinging toolbox 110 is only attached to the bearing assembly 144 when the swinging toolbox 110 is rotating between the unswung and swung position and therefore, the bearing assembly 144 is the main support structure that supports the weight of swinging toolbox 110.

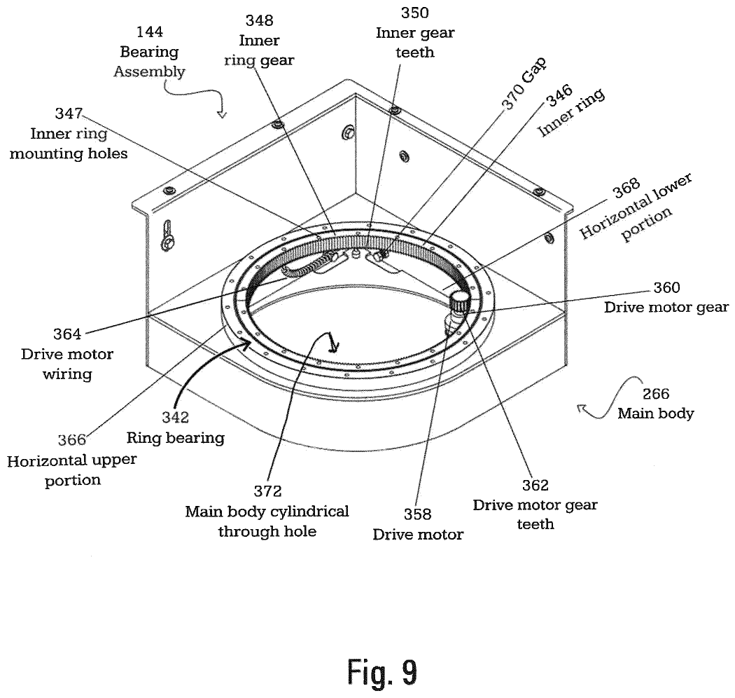

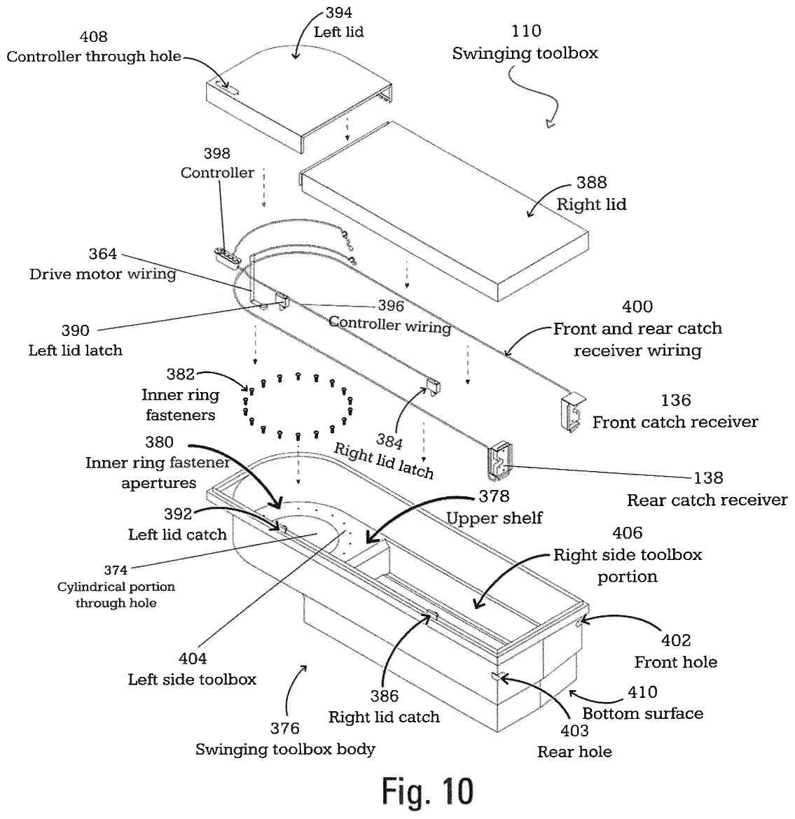

FIG. 9 is a schematic illustration of bearing assembly 144 fully assembled and further illustrates ring bearing 342 mounted on a horizontal upper portion 366 of main body 266, and drive motor 358 and drive motor wiring 364 disposed in a gap 370 that is between the horizontal upper portion 366 and a horizontal lower portion 368 of main body 266. FIG. 9 also further illustrates the drive motor gear teeth 362 of the drive motor gear 360 mating with the inner ring teeth 350 of the inner ring gear 348. FIG. 9 also shows the inner ring 346 and inner ring mounting holes 347. Additionally, the main body 266 of bearing assembly 144 has a main body cylindrical space 372 that goes through the main body that mates with a cylindrical through hole 374 in swinging toolbox 110 which is further discussed in FIG. 10.

FIG. 10 is an exploded assembly view of swinging toolbox 110. Swinging toolbox 110 has a swinging toolbox body 376 with a cylindrical through hole 374 that passes through an upper shelf 378 inside of the swinging toolbox body 376. Upper shelf 378 has toolbox fastener apertures 380 that span the perimeter of the cylindrical through hole 374. Inner ring fasteners 382 are used to mount the swinging toolbox body 376 to the bearing assembly 144 (FIG. 9). Specifically, the toolbox fastener apertures 380 are aligned with the inner ring mounting holes 347 (FIG. 9), and inner ring fasteners 382 go through the toolbox fastener apertures 380 and into the inner ring mounting holes 347 (FIG. 9) of inner ring 346 (FIG. 9) so that the swinging toolbox body 376 is securely mounted to bearing assembly 144 (FIG. 9). FIG. 10 also shows right lid latch 384 that mates with right lid catch 386 on swinging toolbox body which opens and closes right lid 388. Similarly, left lid latch 390 mates with left lid catch 392 on swinging toolbox body which opens and closes left lid 394. FIG. 10 also shows controller 398 that connects to front and rear catch receiver wiring 400, drive motor wiring 364, and controller wiring 396. Controller 398 controls the swing controls of swinging toolbox 110 and the left and right lid release of left and right lids (394, 388). Front and rear catch receiver wiring 400 sends open and close signals between controller 398 and front and rear catch receivers (136, 138). Similarly, drive motor wiring sends signals between the drive motor 358 (FIG. 8) and the controller 398 so that the signals can control the drive motor 358 (FIG. 8). Additionally, controller wiring 396 sends open and close controls between the right and left lid latches (384, 390) and the controller 398. As illustrated in FIG. 10, the front and rear catch receiver wiring 400 along with the front and rear catch receivers (136, 138) are disposed inside of swinging toolbox 110. The front catch receiver 136 abuts the front hole 402 on swinging toolbox body 376 so that the front catch receiver 136 can receive and release front catch 132 (FIG. 3) mounted on frame 106 (FIG. 3). In a similar manner, the rear catch receiver 138 abuts rear hole 403 on swinging toolbox body 376 so that the rear catch receiver 138 can receive and release rear catch 138 (FIG. 3) mounted on frame 106 (FIG. 3). Additionally, drive motor wiring 364 is disposed in swinging toolbox body 376 and is connected to drive motor 358, as illustrated in FIGS. 8-9. Controller 398, controller wiring 396, left lid latch 390, and right lid latch 384 are also disposed in swinging toolbox 110.

The inside of swinging toolbox 110 has a left side toolbox portion 404, a right side toolbox portion 406, and a bottom surface 410 creating a container to hold objects. The left side toolbox portion 404 comprises the upper shelf 378 and the cylindrical through hole 374 that is not covered by bottom surface 401 and is a through opening. The left lid 394 covers the left side toolbox portion 404 and uses left lid catch 392 for opening and closing the left lid 394. The left lid 394 also has a controller through hole 408 that receives controller 398 so that the controller can be accessed on top of left lid 394. In a similar manner, right lid 388 covers the right side toolbox portion 406 and utilizes the right lid catch 386 for opening and closing the right lid 388. The cylindrical through hole 374 in the left side toolbox portion 404 can be utilized in several ways and has many benefits over standard shaped toolboxes because the cylindrical through hole 374 can hold many useful tools such as, but not limited to, contractor buckets, custom insulated buckets, custom air compressors, clips for toolbox accessories, housing for additional power and electronic controls, air and fuel hoses, storing emergency roadside equipment, a barbeque grill, a round cooler, a 5 gallon bucket, and other tools and accessories that a user may want to use or travel with using the swinging toolbox 110 in the bed 104 of vehicle 102. It should be noted that swinging toolbox 110 can also be used manually and does not require motorized devices to operate and use. For example, front and back latch receivers (136, 138) can be manually latched and unlatched to the front and rear catches 132, 134 (FIG. 3), as well as left and right lids (394, 388) being manually operated by ways known in the art regarding opening and closing lids manually, and a non-motorized gear can be implemented for the drive motor gear 360 by ways known in the art regarding manual gears for manually rotating the ring bearing 342 for rotating swinging toolbox 110.

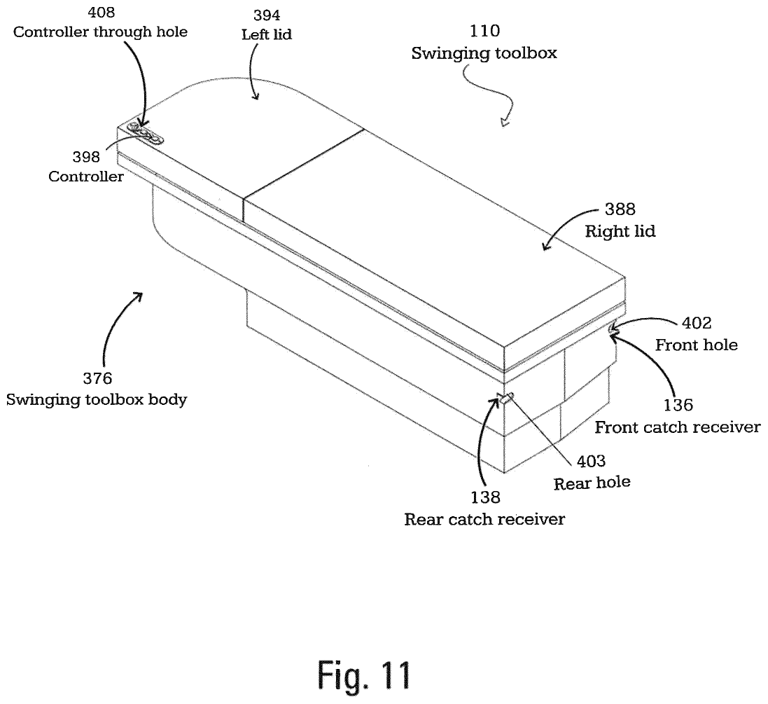

FIG. 11 a schematic illustration of the swinging toolbox 110 in an assembled view. As illustrated in FIG. 11, the left lid 394 covers the left side toolbox portion 404 (FIG. 10) inside of the swinging toolbox body 376, and further illustrates controller 398 disposed in the controller through hole 408 and accessible on the surface of the left lid 394. FIG. 11 also shows right lid 388 covering the right side toolbox portion 406 (FIG. 10) inside of the swinging toolbox body 376. FIG. 11 also shows the left front hole 402 that holds the front catch receiver 136, and the rear hole 403 that holds the rear catch receiver 138.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A swinging toolbox assembly comprising:
a frame configured to mount to a left rail, a right rail, and a bed width vertical face that extends between a driver side and a passenger side of a bed of a vehicle; said frame comprising:
a left bracket configured to attach to said left rail of said vehicle;
a right bracket configured to attach to said right rail of said vehicle;
a crossmember configured to attach to said bed width vertical face of bed of said vehicle, and said left bracket being attached to a left side of said crossmember, and said right bracket being attached to a right side of said crossmember so that said crossmember is between said left bracket and said right bracket so that said left bracket and said right bracket are substantially parallel to each other and separated by a crossmember length;
a bearing assembly configured to mount on top of said frame, and said bearing assembly comprising:
a main body having a main body cylindrical space that goes through said main body, and said main body being configured to attach said frame;
a ring bearing having an inner ring and an outer ring so that said inner ring is configured to rotate inside of said outer ring, and said outer ring being attached to said main body in said main body cylindrical space, and said inner ring having an inner ring gear with inner ring teeth;
a drive motor attached to said main body inside of said main body cylindrical space, and said drive motor having a drive motor gear with drive motor gear teeth so that said drive motor gear teeth mate with said inner ring teeth of said inner ring gear of said inner ring of said ring bearing so that said drive motor is configured to rotate said inner ring of said ring bearing;
a swinging toolbox mounted on said bearing assembly with said swinging toolbox having a swinging toolbox length that is longer than a swinging toolbox width, and said swinging toolbox is configured to rotate between an unswung and a swung position by said drive motor gear mating with said inner gear of said inner ring of said ring bearing so that said inner ring rotates said swinging toolbox; wherein when in said unswung position said swinging toolbox length spans between said driver side and said passenger side of said bed of said vehicle, and wherein when in said swung position said swinging toolbox length spans between a front of bed of said bed of said vehicle and a rear end of bed of said bed of said vehicle;
a front catch mounted on said frame configured to secure said swinging toolbox by mating with a front catch receiver on said swinging toolbox so that when said front catch and said front catch receiver are mated with each other, said swinging toolbox is prevented from rotating in said bed of said vehicle;
a rear catch mounted on said frame configured to secure said swinging toolbox by mating with a rear catch receiver on said swinging toolbox so that when said rear catch and said rear catch receiver are mated with each other, said swinging toolbox is prevented from rotating in said bed of said vehicle.

2. The swinging toolbox assembly of claim 1 wherein said swinging toolbox further comprises:
a swinging toolbox body having a right side toolbox portion configured to hold objects, and a left side toolbox portion having a cylindrical through hole configured to hold a cylindrical object;
a front catch receiver mounted to said swinging toolbox body through a front hole on said swinging toolbox body so that said front catch receiver is configured to mate and unmate with said front catch mounted on said frame;
a rear catch receiver mounted to said swinging toolbox body through a rear hole on said swinging toolbox body so that said rear catch receiver is configured to mate and unmate with said rear catch mounted on said frame;
a left lid configured to cover and uncover said left side toolbox portion and said left lid having a controller through hole;
a right lid configured to cover and uncover said right side toolbox portion;
a controller mounted through said controller through hole so that said controller can be accessed and used from said left lid when said left lid is closed, and wherein said controller controls said left lid, said right lid, said front catch receiver, and said rear catch receiver.

3. A method of assembling a swinging toolbox assembly that is mounted a bed of a vehicle comprising:
attaching a left bracket to a left side of a crossmember;
attaching a right bracket to a right side of a right bracket so that said left bracket, said crossmember and said right bracket form a frame, and said right bracket and said left bracket are substantially parallel and separated between a length of said crossmember;
attaching said frame to rails of a bed of a vehicle comprising:
attaching a left shelf portion of said left bracket on a left rail of said vehicle so that said left bracket spans a left rail horizontal face of said vehicle, wherein said left rail horizontal face of said vehicle is a bed length that extends from a front of bed located adjacent to cabin of said vehicle to a rear end of said bed that is opposite said front of bed along said bed length;
attaching a right shelf portion of said right bracket on a right rail of said vehicle so that said right bracket spans a right rail horizontal face of said vehicle, wherein said right rail horizontal face of said vehicle is said bed length that extends from said cabin of said vehicle to said rear end of said bed, and said cabin is located opposite said rear end and extends said bed length;
attaching said crossmember to a bed width vertical face of said bed of said vehicle that extends a bed width of said bed of said vehicle wherein said bed width extends between a driver side of said vehicle and a passenger side of said vehicle;
mounting a front catch to said to a right vertical portion of said right bracket of said frame, wherein said right vertical portion is substantially perpendicular to said right shelf portion of said right bracket;
mounting a rear catch to said to a left vertical portion of said left bracket of said frame, wherein said left vertical portion is substantially perpendicular to said left shelf portion of said left bracket;
attaching a bearing assembly to said left bracket and said crossmember of said frame so that a left horizontal portion of a main body of said bearing assembly is attached to said left shelf portion of said left bracket and a right horizontal portion of said main body of said bearing assembly is attached to said crossmember;
attaching a ring bearing to a horizontal upper portion of said main body of said bearing assembly so that an outer ring of said ring bearing is surrounds a main body cylindrical through hole of said main body of said bearing assembly;
mating drive motor gear teeth of a drive motor gear with inner ring teeth of an inner ring gear located inside of an inner ring of said ring bearing so that said mating of drive motor gear teeth and said inner ring teeth causes said inner ring to rotate inside of said outer ring when said drive motor gear rotate;
mounting a swinging toolbox to said bearing assembly by attaching an upper shelf of a swinging toolbox body to said inner ring of said ring bearing so that a cylindrical through hole located on said upper shelf aligns with said main body cylindrical through hole of said bearing assembly so that said swinging toolbox rotates between an unswung position and a swung position inside of said bed of said vehicle when said inner ring gear rotates with said drive motor gear, wherein a swinging toolbox length of said swinging toolbox spans said bed width in said unswung position, and said swinging toolbox length spans said bed length in said swung position;
mounting a front catch receiver in a front hole of said swinging toolbox body so that said front catch receiver mates with said front catch when said swinging toolbox is in said unswung position and said swinging toolbox is prevented from rotating when said front catch and said front catch receiver are mated together;
mounting a rear catch receiver in a rear hole of said swinging toolbox body so that said rear catch receiver mates with said rear catch when said swinging toolbox is in said swung position and said swinging toolbox is prevented from rotating when said rear catch and said rear catch receiver are mated together;
attaching a right lid to a right lid catch on said swinging toolbox body;
attaching a left lid to a left lid catch on said swinging toolbox body;
mounting a controller inside of a controller through hole on said left lid so that said controller can be used and accessed on top of said left lid when said left lid is closed so that said controller controls said left lid, said right lid, said front catch receiver, and said rear catch receiver.

4. A method of using a swinging toolbox of a swinging toolbox assembly mounted on a bed of a vehicle comprising:
positioning said swinging toolbox in an unswung position so that a swinging toolbox length of said swinging toolbox extends along a bed width between a driver side and a passenger side of said vehicle, and wherein said swinging toolbox has a bearing assembly side attached to a bearing assembly having a ring bearing that allows rotation of said swinging toolbox, and a catch side that secures said swinging toolbox to a frame mounted on a rail of said vehicle and said bearing side is opposite said catch side along said swinging toolbox length;
securing said swinging toolbox in an unswung position by mating a front catch receiver located on said catch side of said swinging toolbox with a front catch located on said frame of said swinging toolbox assembly and wherein said frame is mounted on said rail of said vehicle so that said front catch receiver mated with said front catch maintains said swinging toolbox in said unswung position;
rotating said swinging toolbox secured to said front catch from a said unswung position to a swung position so that said catch side rotates about said bearing assembly side inside of said bed of said vehicle comprising:
disconnecting said front catch receiver from said front catch;
rotating said catch side of said swinging toolbox away from a front of bed that is adjacent to a cabin side of said bed and towards a rear of bed located opposite from said front of bed along a bed length of said bed of said vehicle;
positioning said swinging toolbox in an unswung position so that said swinging toolbox length of said swinging toolbox extends along said bed length of said bed of said vehicle;
securing said swinging toolbox in a swung position by mating a rear catch receiver located on said catch side of said swinging toolbox with a rear catch located on said frame of said swinging toolbox assembly so that said rear catch receiver mated with said rear catch maintains said swinging toolbox in said swung position;
rotating said swinging toolbox in an unswung position to a swung position by disconnecting said rear catch receiver from said rear catch and rotating said catch side about said bearing side so that said catch side is rotated away from said rear of bed and towards said front of bed until said swinging toolbox length of said swinging toolbox extends along said bed width of said bed of said vehicle.
